(19) United States
(12) Patent Application Publication
(10) Pub. No.: US 2013/0283590 A1
(43) Pub. Date: Oct. 31, 2013

(54) MOBILE DUCT ASSEMBLER

(71) Applicant: Curtis Broughton, Georgetown, TX (US)

(72) Inventor: Curtis Broughton, Georgetown, TX (US)

(21) Appl. No.: 13/457,563

(22) Filed: Apr. 27, 2012

(51) Int. Cl. B23P 11/00; B23P 19/00

(52) U.S. Cl. 29/428; 29/700

(57) ABSTRACT

A duct section can be assembled from duct pieces without lifting or turning the duct pieces during assembly. For example, a duct assembler is provided to hold the duct pieces at an ergonomic working height. The duct assembler includes a frame, a mast, a carriage, and tines protruding horizontally from the carriage. The mast is vertically extensible to raise and lower the tines, so as to select a working height. Moreover, the mast can be vertically extensible to raise an assembled duct section into position for installation. A non-contact positioning system and an integrated computer may be provided to aid a worker in preparing and positioning the duct section.

### BACKGROUND

1. Technical Field

The present invention relates to assembly and installation of heating ventilation and air conditioning (HVAC) ductwork. More particularly, embodiments and aspects of the present invention relate to apparatus and methods for assembling sheet metal duct pieces into a duct section; and, also, to apparatus and methods for positioning and installing a duct section.

2. Description of Art

Sheet metal ductwork or conduit has been in use for heating ventilation and air conditioning (HVAC) through more than a century. Typically, ductwork is made strong enough to guide airflow, without excess material as might be required to support traffic loads. Accordingly, systems of ductwork have typically been installed on hangers mounted to the building structure.

Sheet metal ductwork is not easy to install at different elevations. For efficient manufacture and delivery, the ductwork is provided in pieces of pre-determined lengths. The pieces then are assembled together onsite to fit portions of a construction drawing. Typically, several pieces are assembled at floor level, in shop or field, into a “section” of ductwork. Mechanical constraints dictate that final assembly of the sections, to form a complete duct system matching the construction drawing, will be accomplished at hanger height. Typically, a first duct section is lifted and secured to a first set of hangers. Another duct section then is lifted and secured to the first duct section, and then to another set of hangers. The sequence of section assembly, lifting, and securing is repeated for each duct section throughout the project until the complete layout has been installed.

There is a long standing contrast between the manufacture and the installation of sheet metal ducting. A typical manufacturing shop is highly automated, using more than thirty distinct pieces of equipment. For example, an HVAC metal shop may include a coil line that feeds a line of roll formers, corner formers, lockformers, and plasma cutters. At the end of the line, a duct piece of pre-determined length and shape may be provided. By contrast, field installation relies on skilled manual labor. Typical field equipment is limited to hand tools, a construction drawing, and lifters used for raising duct sections and for personnel.

As can be appreciated, the bulk of profit in HVAC sales accrues to the metal shop operators. Field install labor productivity has become the risk center of the business. Thus, installation contractors have long felt a need for ways to obtain consistently higher productivity from installers. Yet the conventional apparatus and methods for assembly have inherent limits. In particular, the ergonomics of the conventional apparatus and methods limit the amount of production that can be achieved by installers. Additionally, conventional apparatus and methods for duct installation have inherent mechanical limits. In particular, conventional apparatus and methods are not well adapted for efficiently positioning heavy sections of sheet metal ductwork.

### BRIEF DESCRIPTION OF THE INVENTION

Therefore, in aspects of the invention, apparatus and methods are provided for ergonomic assembly of a duct section in shop or field. Also, in aspects of the invention, apparatus and methods are provided for lifting and installation of a duct section.

In embodiments of the invention, a duct section can be assembled from duct pieces without lifting or turning the duct pieces during assembly. For example, a duct assembler is provided to hold the duct pieces at an ergonomic working height. The duct assembler includes a frame, a mast, a carriage, and tines protruding horizontally from the carriage. The mast is vertically extensible to raise and lower the tines. The tines are configured to receive the duct pieces.

In embodiments, a duct assembler apparatus includes a frame, a vertical mast mounted to the frame, and a pair of tines extending to a sufficient distance from the vertical mast for longitudinally supporting one or more duct pieces

In some embodiments, the mast is vertically movable to lift duct pieces carried on the tines, by adjusting the height of the tines.

In aspects of the invention, a duct section of HVAC duct pieces can be assembled at ergonomic height with minimal handling. For example, a method for assembling the duct pieces includes supporting two or more duct pieces with adjacent flanged openings in registry; then aligning, clamping, and fully securing the adjacent flanges to assemble a duct section, without turning the duct section about its lengthwise axis. As another example, a method for assembling the duct pieces includes supporting two or more duct pieces with adjacent flanged openings in registry; then aligning, clamping, and fully securing the adjacent flanges to assemble a duct section, without vertically moving the duct section.

In certain aspects, the duct section is supported along at least a majority of its length, and the support is vertically adjustable to position the duct section. The support also may be horizontally adjustable to support and stabilize small to larger ducts. In select aspects, the duct section is supported internally.

These and other objects, features and advantages of the present invention will become apparent in light of the detailed description of the best mode embodiment thereof, as illustrated in the accompanying drawings.

### BRIEF DESCRIPTION OF THE DRAWINGS

FIG. 1 is a perspective view of a conventional method for assembling together two HVAC duct pieces at floor level. Show leg bent behind him kneeling on floor.

FIG. 2 is a perspective view of a method for assembling together two HVAC duct pieces at an ergonomic height, according to an aspect of the present invention.

FIG. 3 is a perspective view of a duct assembler, according to a first embodiment of the present invention.

FIG. 4 is a perspective view of the duct assembler shown in FIG. 3, in use for assembling a duct section, according to one aspect of the present invention.

FIG. 5 is a perspective view of a duct assembler, according to a second embodiment of the present invention.

FIG. 6 is a schematic view of a duct section being assembled on the duct assembler shown in FIG. 5, according to another aspect of the present invention.

FIG. 7 is a perspective view of a duct section assembled on the duct assembler shown in FIG. 5.

FIG. 8 is a perspective view of a conventional lifter in use for installing a duct piece.

FIG. 9 is a schematic view of several conventional lifters in use for installing a duct section.

FIG. 10 is a schematic view of the duct assembler shown in FIG. 3, in use for installing a duct section, according to one aspect of the present invention.

FIG. 11 is a schematic view of the duct assembler shown in FIG. 3, in use for installing a duct section, according to another aspect of the present invention.

FIG. 12 is a schematic view of the duct assembler shown in FIG. 3, in use with a non-contact positioning system, according to another aspect of the present invention.

FIGS. 13A and 13B show schematic views of the duct assembler shown in FIG. 3, in use with a plasma cutter, according to yet another aspect of the present invention.

FIG. 14 is a perspective view of another duct assembler, according to a third embodiment of the present invention.

FIGS. 15A and 15B are schematic views of yet another duct assembler, according to a fourth embodiment of the present invention.

FIG. 16 is a schematic view of a telescoping tine usable in embodiments of the invention.

FIG. 17 is a schematic view of a control interface usable in embodiments of the invention.

FIG. 18 is a schematic view of an exemplary interactive electronic duct layout drawing for use with embodiments of the invention.

FIG. 19 is a schematic view of a duct assembler including a welding machine, according to another aspect of the invention.

FIG. 20 is a schematic view of a duct assembler including a tap layout display, according to an embodiment of the present invention.

### DETAILED DESCRIPTION OF THE DRAWINGS

Exemplary embodiments of the inventive concept are illustrated in the accompanying drawings. Where the same or similar reference characters are used throughout the drawings, then, where possible, such reference characters indicate the same or like parts.

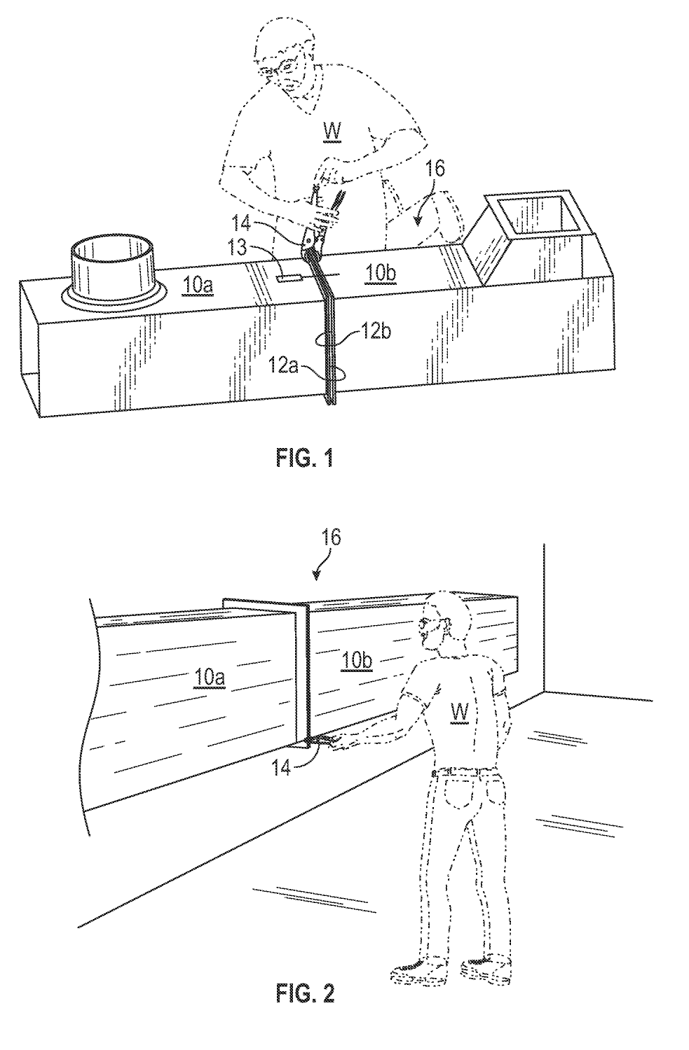

FIG. 1 shows in perspective view a conventional method for assembling together two HVAC duct pieces 10a, 10b. Before the step shown in the figure, a worker W (shown in phantom line) already has gasketed the adjacent flanged ends 12a, 12b of the duct pieces 10a, 10b, and has placed the two duct pieces on a floor or table with their gasketed ends close together. The worker W now uses a rod 13, such as the shaft of a screwdriver, to align bolt holes of the adjacent flanged ends. Simultaneously, the worker w uses a vise grip or clamp 14 to firmly pull together the flanged ends 12a, 12b. Next, the worker W will use bolts or spring clamps to secure the ends of the duct pieces on all four sides, thereby forming a short duct section 16.

Alignment, and installing bolts and clips, often require turning over the duct section multiple times around its lengthwise axis. When bolts are used, the worker W proceeds to a subsequent step of tightening the bolts in sequence around the flange. This step of tightening often requires turning over the duct section multiple times to make sure all bolts are tight.

Thus, the step of securing on all four sides, with duct pieces resting on a floor or table, presents challenges in implementation. This step typically requires subsidiary steps of picking and turning the two duct pieces together. The worker W's ability to pick and turn is limited by the size, weight and extent of the partly assembled duct section. Although it is possible to pick and turn two or three small duct pieces, larger sections and transitionals are typically unwieldy, even with the aid of additional workers. A related challenge is that partly-assembled duct sections are “floppy” at the unbolted sides. Thus it is necessary to avoid putting excess bending stress on already-bolted sides of the flange. In the sometimes constrained time and space available for field install, this challenge can be hard to meet.

Another challenging aspect is the posture required of the worker W. Throughout a workday, the worker W is crouched or kneeling over duct pieces. Although knee pads and back braces may mitigate risks of injury to joints and muscles, it is undeniable that the work in itself does pose such risks.

By contrast to the conventional approach, FIG. 2 shows an aspect of the present invention in which several duct pieces 10 of various sizes all are supported together at an ergonomic height for assembly into a duct section 16. As shown, the adjacent flanged openings of the duct pieces are held in registry. The worker W can maintain an upright posture during the assembly steps of aligning, clamping, and fully securing the adjacent flanges. Additionally, it is not necessary to pick and turn the three duct pieces. Instead, the worker W can duck down under the duct pieces, or can raise the support (not shown) for installing bolts or clamps to fully secure the undersides of adjacent flanges along the duct section 16. The duct section does not need to be further handled until it has been fully assembled to a rigid structure.

FIG. 2 shows the duct pieces 10 suspended from an unspecified support. However, it is highly desirable to have a mobile apparatus that can permit assembly according to the above-described aspect of the present invention.

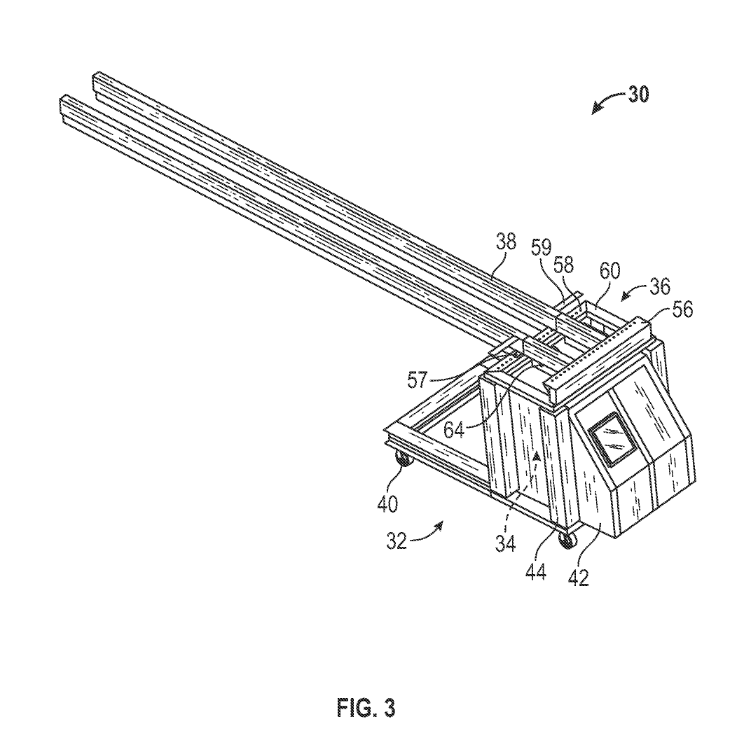

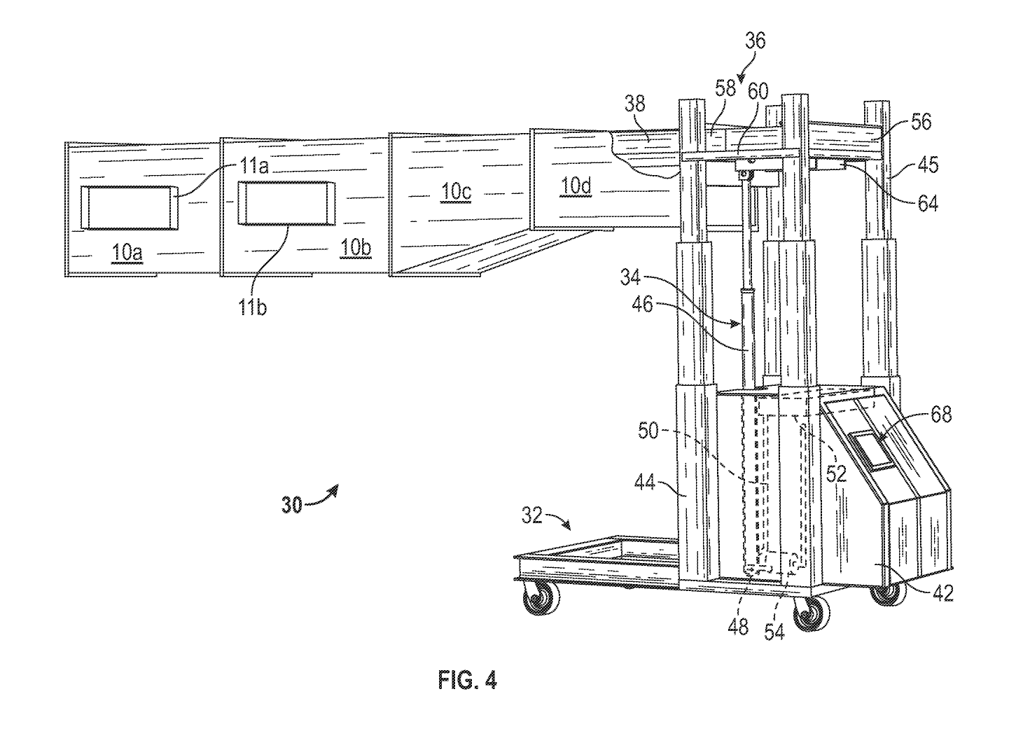

Thus, according to one embodiment of the present invention, FIG. 3 shows in perspective view a mobile duct assembler 30. In FIG. 4, the duct assembler 30 is shown in use as an assembly platform for fastening together a plurality of small duct pieces 10 to form a duct section 16. Referring to both FIGS. 3 and 4, the duct assembler includes a frame 32, which supports a vertical mast assembly 34. The mast assembly is mounted near a first (proximal) end of the frame. The mast assembly, at its top end, supports a carriage 36 that holds tines 38. The tines extend horizontally from the mast assembly to their distal ends beyond the other (distal) end of the frame. In use, the tines longitudinally support the plurality of duct pieces 10. Therefore, the distal ends of the tines are disposed a sufficient length from the carriage 36 in order to accommodate the duct pieces. Near their proximal ends, each tine is provided with a duct stop 59 (further discussed below).

The frame is supported by wheels 40. The frame includes a cabinet 42, which houses working parts of the mast assembly 34. The frame also includes tubular uprights 44, which receive legs 45 of the carriage 36. The frame extends from the mast assembly toward the distal ends of the tines 38, such that wheels at the distal end of the frame act as outriggers to withstand the weight of the duct pieces 10 carried on the tines. The frame also may house counterweights or ballast to resist the weight of the duct pieces.

The mast assembly 34 includes a hydraulic cylinder (mast) 46 for moving the carriage 36 up and down on the frame 32. In the embodiment shown, the legs 45 of the carriage keep the carriage aligned with the uprights 44 of the frame, but do not bear weight. The legs 45 can be made telescopic to permit extension of the mast 46 beyond twice the height of the frame 32. In other embodiments, one or more legs may include their own hydraulic cylinders and in select embodiments, the functions of the mast 46 may be entirely incorporated into the legs 45.

The mast system 34 includes a supply connection 48 and a vent connection 50 connected with the mast 46. The vent connection leads from the mast 46 to a reservoir 52, which provides hydraulic fluid to a pump 54. The pump in turn supplies pressurized hydraulic fluid to the supply connection of the mast. The pump and reservoir are housed within the cabinet 42. Drain and refill fittings (not shown) for the pump and reservoir may also be incorporated into the cabinet. In other embodiments, the mast system may be electrically or pneumatically powered.

The cabinet 42 additionally may contain a tool and material storage box. The top of the cabinet may be configured with grips or slides for holding paper plans, and/or with a computer 68 for review of electronic plans and for other functions as further described below. The cabinet also may house a system for providing electrical power to other parts of the duct assembler. For example the cabinet may have an electrical input plug and cords stored on cord reels within the cabinet. Additionally or alternatively, the cabinet may house an electrical storage system including one or more battery and a charger. In certain embodiments, the cabinet may house an arc welder. The cabinet may house an air compressor supplying a pneumatic hose. The cabinet also may house a pressurized caulking container and associated piping.

The carriage 36 includes legs 45 as discussed above. The carriage also includes a rack 56, mounted on a proximal pair of the legs; a bar 58, mounted on a distal pair of the legs; and side braces 60 forming a rectangle with the rack and the bar. The rack is shaped as a C-channel with its opening toward the distal end of the frame 32, and with the proximal end of each tine 38 being held within the rack. In the rack are formed a first or proximal linear array of positioning holes 57. Any of the positioning holes can receive a fixing pin (not shown) for fixing a proximal end of one of the tines. The bar 58 has a flat upper surface, on which the tines are supported. In this flat upper surface are formed a second or distal linear array of positioning holes 57 for receiving additional fixing pins (not shown). Together, the positioning holes in the rack and the bar enable generally rigid and parallel location of the two tines 38 for supporting one or more duct pieces. In some embodiments, the fixing pins are included on the tines.

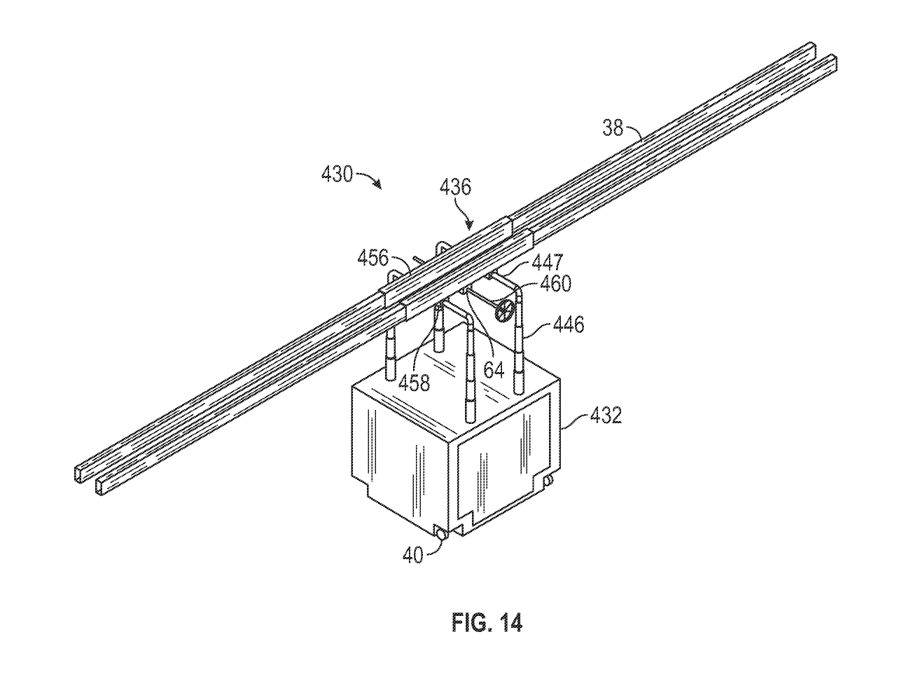

Each of the tines 38 also includes a flange with a threaded hole or nut 64. It will be appreciated that the threaded holes 64 allow for lateral adjustment of the tines by a jack screw or the like (as shown, for example, by reference character 460 in FIG. 14, discussed below). In embodiments using a jack screw, the fixing pins are omitted for smooth lateral movement of the tines.

The computer 68 typically includes a processor, a display, and at least one input device such as a keyboard mouse or touchscreen. The computer can be, but is not limited to being, a tablet type computer as shown in FIGS. 3-4.

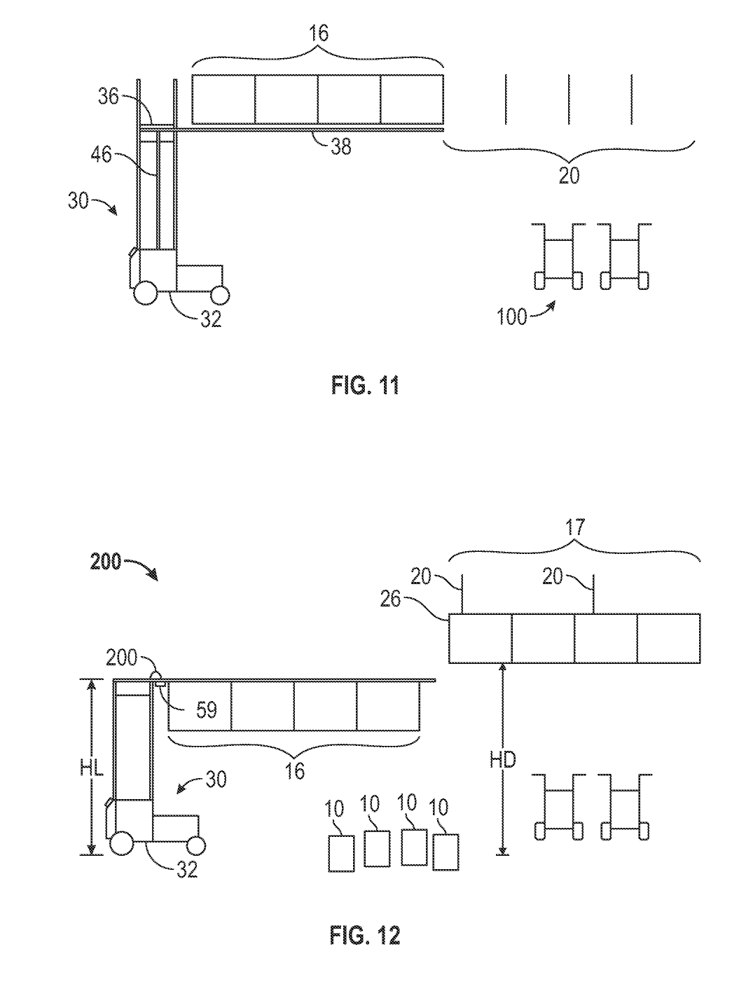

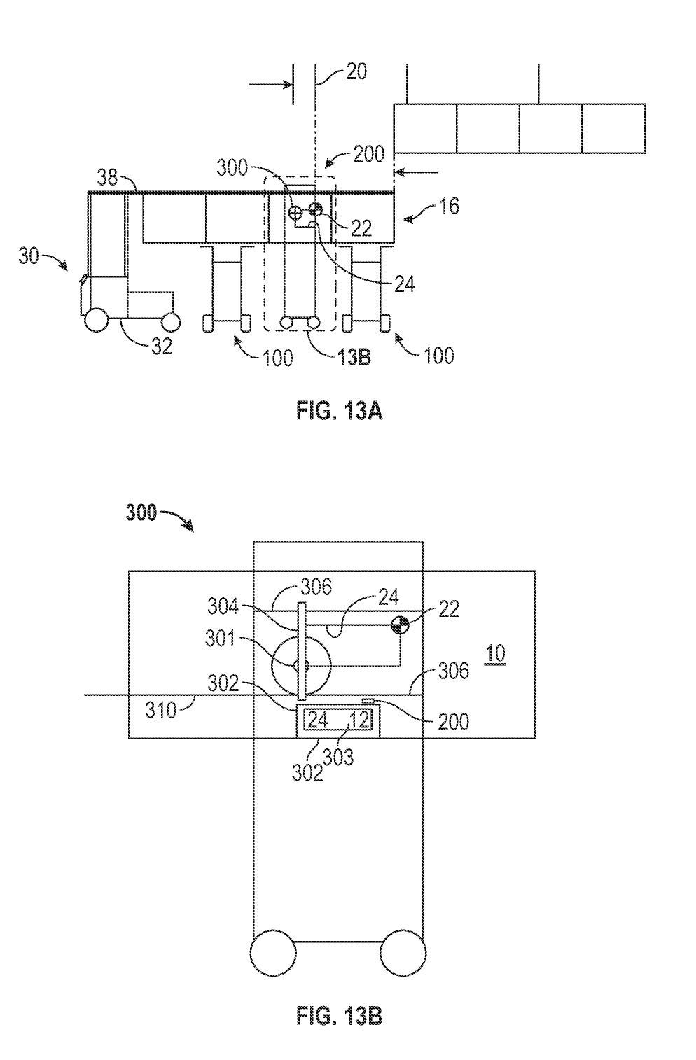

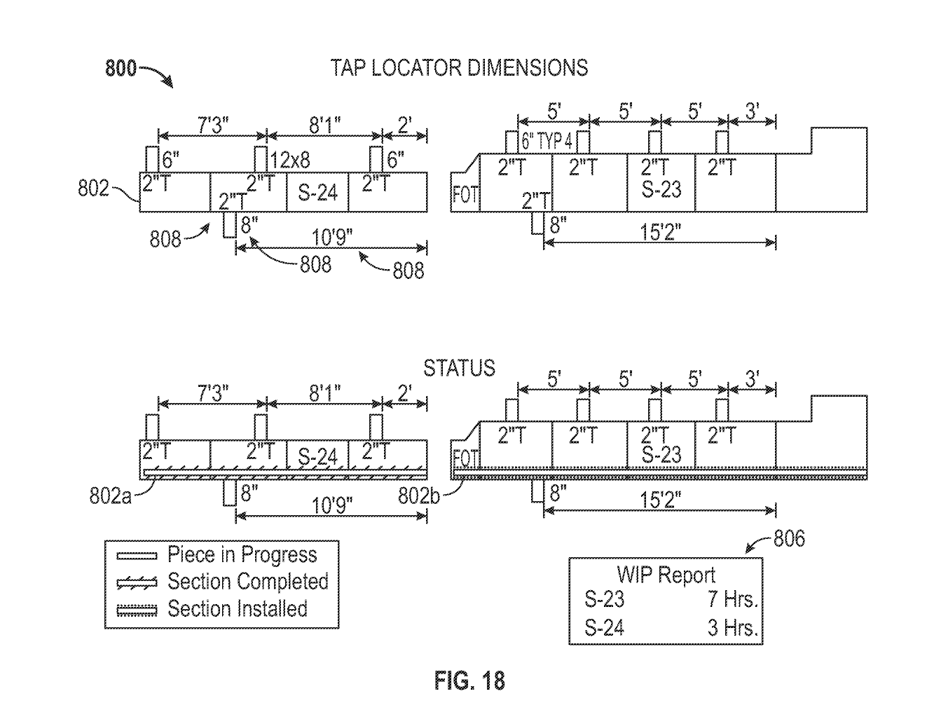

The computer display is provided for viewing electronic drawings, for example as shown in, and further discussed with reference to, FIG. 18. The computer input devices may include a bar code reader 69, for identification of pre-marked duct pieces against an inventory database and construction drawing, as further discussed with reference to FIG. 18. In some embodiments, the computer 68 can automatically operate a jack screw, pneumatic or hydraulic cylinder, or the like, in order to adjust the tine spread and height based on information received from an input device, for example, from the bar code reader scanning a duct piece. In some embodiments, the computer may be configured to operate a non-contact positioning system 200 and/or a plasma cutter system 300, as further discussed below with reference to FIG. 12 and FIG. 13.

Associated with computer operation of a positioning system, the wheels 40 may be motor-driven. For example, each wheel may be driven by a hub motor. Alternatively, the two wheels under the cabinet 42 may be driven by a single common motor (not shown) that is housed in the cabinet.

Typically, it is desirable for motorized wheels to be operable from the vicinity of the cabinet. For example, the computer 68 can individually power the wheels 40 to position the duct assembler 30 according to a portion of a duct layout as selected at the computer. For this purpose, GPS, laser, RFID, or other non-contact positioning system(s) can be included as input device(s) to the computer. This aspect of the invention is further discussed below with reference to FIGS. 12 and 18.

Thus, in a first embodiment of the invention as shown in FIGS. 3 and 4, a duct assembler 30 includes tines 38 that are mounted on wheels 40 for movably supporting one or more duct pieces 10 at an ergonomic working height. The ergonomic working height reduces risks of injury to installers, and enhances speed of production. Additionally, the tines 38 are vertically adjustable by a mast assembly 34, such that the working height can be adjusted based on duct size to suit a worker W.

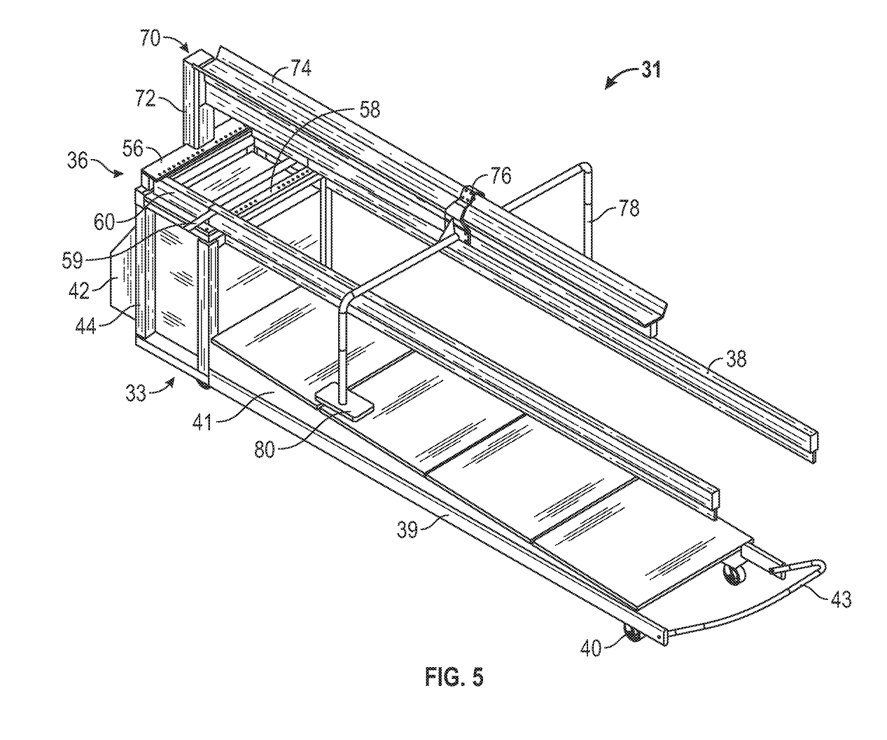

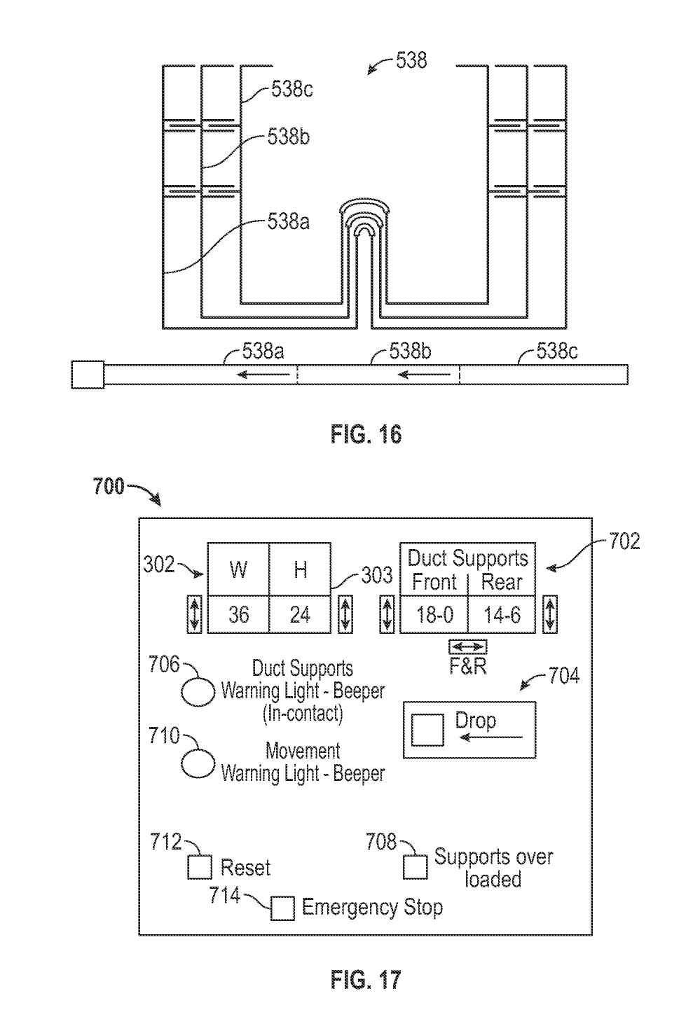

FIGS. 5-7 show a second embodiment of the invention. In FIG. 5, a larger duct assembler 31 includes many of the same components as does the duct assembler 30 shown in FIGS. 3-4. However, FIG. 5 shows that the frame 33 of the duct assembler 31 extends much further toward the distal end of the tines 38. Also, the larger duct assembler is provided with a skid plate 41 to assist in unloading duct pieces from the tines 38, which may be made telescopic as further discussed below with reference to FIG. 16. Additionally, the larger duct assembler has a tow handle 43 for steering.

The larger duct assembler 31 also is provided with a tool beam assembly 70. The tool beam assembly includes a post 72 for mounting a U-rail 74 onto the carriage 36 or onto the frame 32. The U-rail supports roller brackets 76, which in turn support tool trays 80 via pipe arms 78. In some embodiments the tool beam assembly can be vertically movable by the mast assembly 34, along with the carriage 36. In other embodiments it is contemplated that the mast assembly may be omitted from the larger duct assembler 31 (owing to the increased weight of the duct pieces), such that the carriage 36 is fixedly mounted onto the frame 32.

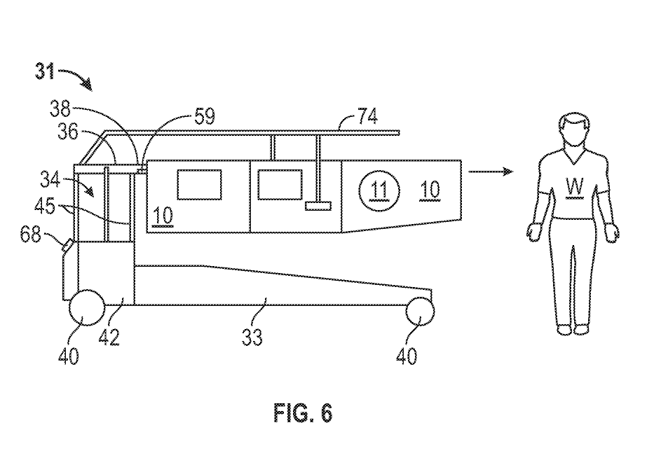

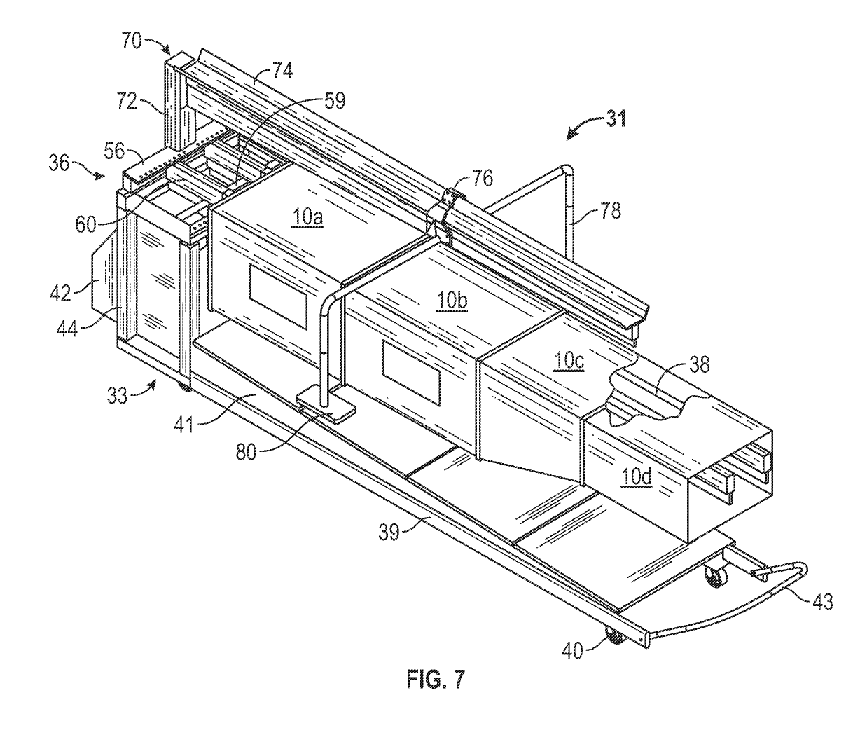

FIG. 6 shows a schematic view of duct pieces 10 and taps 11 being assembled on the larger duct assembler 31. FIG. 7 shows in perspective view the same situation. Note that the tool trays 80 can be slid along the U-rail 74, so that a worker W has all the necessary tools and materials to complete the task at hand.

In use, a worker W can individually load duct pieces 10 onto the tines 38. Typically the duct pieces are loaded so that the tines internally support them. In other aspects, the duct pieces are loaded such that the tines extend longitudinally under the bottom surfaces of the duct pieces. The worker then assembles the duct pieces into a duct section 16.

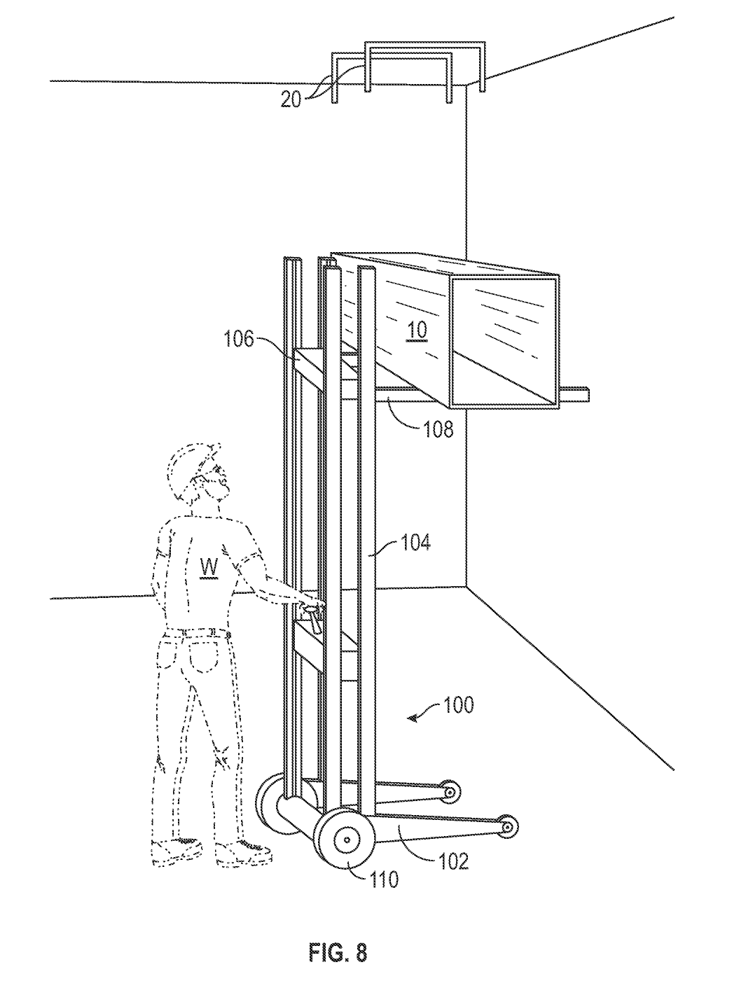

Duct jacks or lifters 100, as further discussed below with reference to FIG. 8, can be brought in under the duct section for raising and installing the duct section. Alternatively, the duct assembler 30 can be used for raising and installing the duct section. In either case, when the duct section is supported by structure other than the duct assembler 30, the tines 38 then can be lowered and retracted from their supporting position. The tines can be retracted as further discussed below with reference to FIG. 14; or telescopically, as further discussed below with reference to FIG. 16; or the tines can be retracted by moving the duct assembler as a whole. The duct assembler then is ready for repositioning to assemble and install another duct section.

Beyond providing a horizontally mobile platform for assembling a duct section 16 at ergonomically adjustable height, the mobile duct assembler 30 also can be configured for raising an assembled duct section to hangers for installation. This feature will be described by comparison to use of a conventional duct lift, shown in FIG.

8.

Referring to FIG. 8, a conventional lifter 100 includes a frame 102, on which is mounted a vertical mast 104. The mast supports a bracket or carriage 106, from which forks 108 protrude generally horizontally away from the mast. The bracket or carriage is vertically movably supported by the mast, and can be driven up and down to raise and lower a load supported on the forks. The frame 102 rests on wheels 110.

In using the conventional lifter, the forks 108 support a small duct piece 10 at its outer undersurface, such that the duct piece must be meticulously balanced on the forks as the forks are raised to bring the duct piece adjacent to hangers 20.

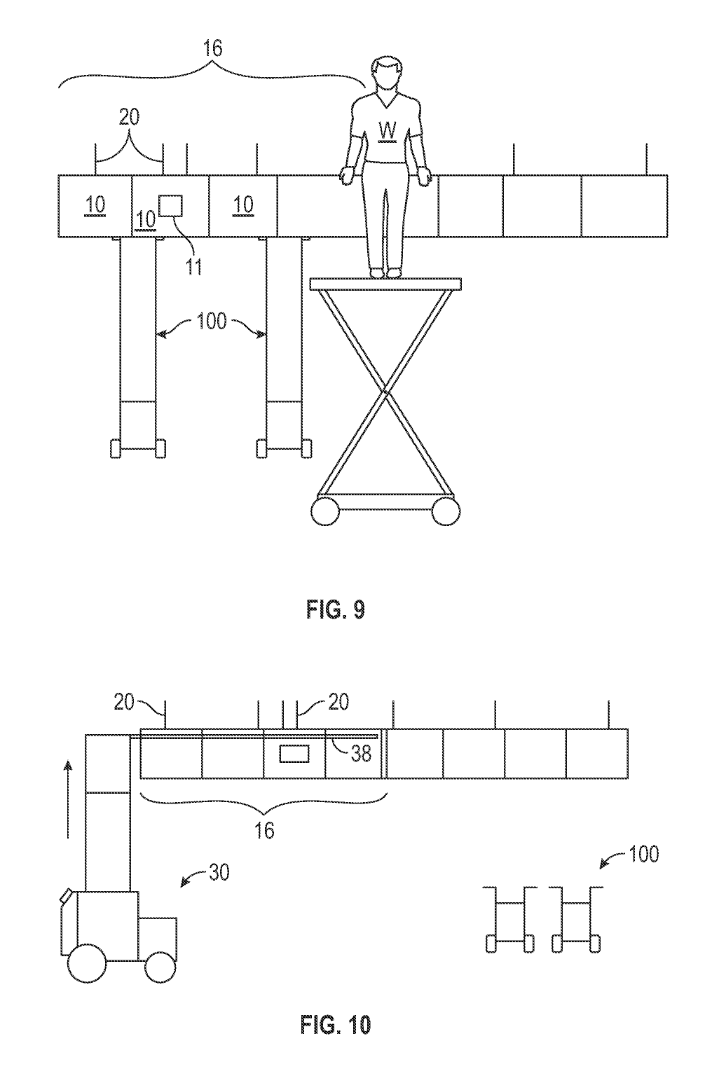

Thus, it will be appreciated that positioning and installing even a small duct piece, using the forks of a conventional lifter, can be difficult and slow. Sometimes, as shown in FIG. 9, multiple lifters will need to be coordinated for installing a pre-assembled duct section. In case it is desired to assemble together two or more duct pieces, this is not easily accomplished while the duct pieces are held on separate duct lifters. In particular, vertical and horizontal alignment of the duct pieces presents challenges. Thus, referring back to FIGS. 3 and 4, the legs 45 and the mast 46 of the duct assembler 30 can be made sufficiently vertically extensible for raising and lowering the tines 38 to hanger height, as shown schematically in FIGS. 10-11. The legs and mast can be extensible by any one or more of pneumatic, hydraulic, or electrical power devices, or by a hand crank and jack screws.

While lifting a duct section 16, the tines 38 can provide longitudinal internal support to the duct section (as shown in FIG. 10), which thereby hangs from the tines rather than being balanced upon them. Alternatively, the tines 38 can support the duct section longitudinally at its undersurface shown in FIG. 11. Longitudinal support, along more than a majority of the duct section length, obviates a great deal of the difficulty presented by balancing a duct section crosswise on conventional lifts. Typically, the tines extend at least the majority of the length of the duct section. More typically, the tines extend nearly the entire length of the duct section, for example, more than about 85% of the duct section length.

Thus, the duct assembler 30 can be made vertically extensible so as to replace multiple conventional duct lifters. Additionally, the duct assembler eliminates a need for coordinating simultaneous raising/lowering of multiple conventional lifters, which typically need to be spaced apart too far for a single worker to reach. Thus, the duct assembler can significantly reduce personnel costs for the lifting phase of install. Overall, it is expected that the duct assembler may reduce total install labor hours by more than one tenth (10%) to as much as one quarter (25%).

For ease of positioning a pre-assembled duct section 16, FIG. 12 shows another embodiment of the invention, in which the duct assembler 30 can be provided with a non-contact positioning system 200 such as Trimble Field Link and Trimble Total Station. Other examples of non-contact positioning systems include GPS or RFID transponder triangulation.

With reference to a datum such as the duct stops 59, the non-contact positioning system 200 can detect and indicate distance to the distal end of a duct section mounted on the duct assembler. The non-contact positioning system also can measure and indicate horizontal and vertical distance to a near end of an already-installed duct section, or to a hanger to which the duct section 16 will be fastened. In combination with the integrated computer 68, the non-contact positioning system can direct motion of the wheels 40 and of the mast 46 so as to automatically position the duct section 16 for installation.

In aspects of the invention, using the non-contact positioning system 200 enables assembly of the duct section 16 directly below the location where the duct section will be raised and installed. The duct section 16 can of course be assembled somewhat off this position for convenience of the worker W, and in such case, the non-contact positioning system 200 then enables re-positioning the duct section, prior to lift. Overall, use of the non-contact positioning system 200 can minimize in-the-air repositioning of the duct section 16, which may be both weighty and unwieldy.

During installation of pre-assembled duct sections, it is a known problem that pre-cut taps may not exactly line up to pre-installed hangers for the branch ducts that are meant to come off the taps. Thus, it would be advantageous for installers if they were able to quickly cut taps in accurate registry with branch duct hangers.

Accordingly, FIGS. 13A-13B show in schematic view the duct assembler apparatus shown in FIG. 3, in use with a plasma cutter system 300 according to another aspect of the present invention. The plasma cutter system 300 includes a plasma cutter 301. In embodiments, the plasma cutter is automatically movable by a control unit 302 on rails 304, 306. The control unit 302 provides for selecting rectangular plasma cut dimensions via an interactive display 303, as shown in FIG. 13B. In embodiments, the control unit can be integrated into the computer 68 that is discussed above with reference to FIGS. 3 and 4. In other embodiment the control unit can be integrated into a control panel 700, as further discussed below with reference to FIG. 17. In select embodiments the control unit can be adapted to enable additional non-rectangular cut shapes, such as circular, elliptical, or re-entrant cuts.

As shown in FIG. 13, the plasma cutter 301 is vertically movable on a Y-rail 304 and is horizontally movable on X-rails 306 so that X-Y CNC cutting can be accomplished by the control unit 302. For example, the plasma cutter is movably mounted on the Y-rail 304. The Y-rail is movably engaged with the X-rails. The control unit 302 controls operation of motorized wheels for positioning the plasma cutter and the Y-rail.

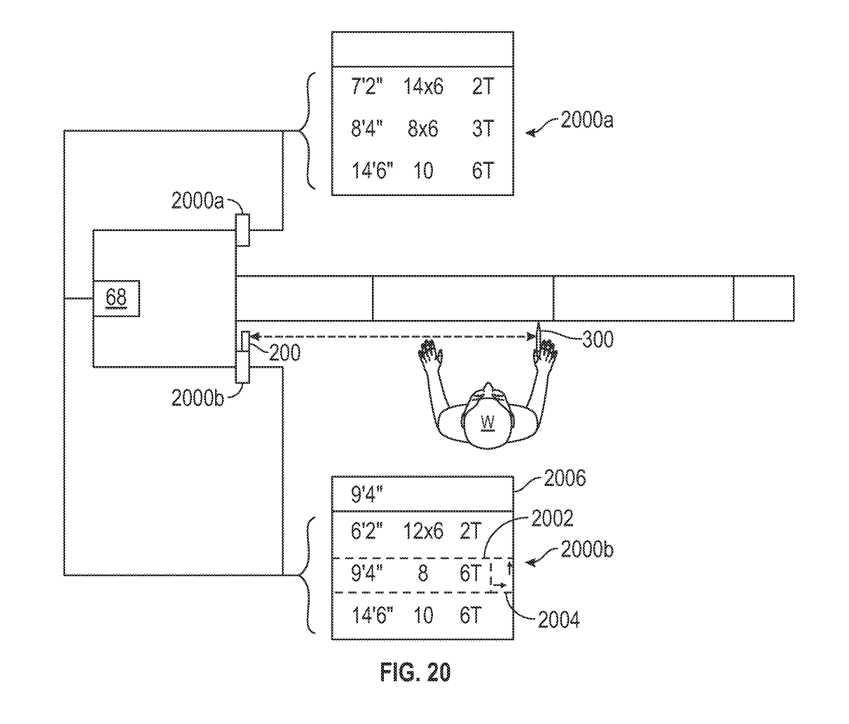

In FIG. 13, the control unit is shown aligned with a pre-installed hanger 20 by means of the non-contact positioning system 200. Thus, the plasma cutter 301 can be positioned relative to the known position of the control unit. Thus, the laser alignment tool can be used to determine a starting place or datum 22 for making a plasma cut 24 in one of the duct pieces 10, in line with the pre-installed duct hanger 20. Alternatively, a worker aligns the control unit to the datum 22, based on a position table listing tap dimensions and tap locations relative to the duct stops 59, as further discussed below with reference to FIG. 20. Once aligned with the dataum 22, the plasma cutter 300 can be operated push-button style to make the cut 24. Advantageously, this combination of the laser alignment tool 200 with the plasma cutter system 300 provides for on-site manufacturing and assembly of a duct section with accurately located taps.

Other various embodiments of the invention may be provided. As one example, FIG. 14 shows another duct assembler 430 wherein a cabinet chassis 432 is mounted on wheels 40. The cabinet chassis supports a carriage assembly 436 via four hydraulic legs 446 that are driven by a mast system housed within the cabinet. Each pair of telescopic legs is joined by a cross-rail 447. The carriage assembly holds tines 38 within tubes 456, which are mounted on the cross-rails 447 via sliding guides 458. The tubes are adjustable toward and away from each other by rotating engagement of a jack screw 460 into nuts 64 mounted to each tube. The tines 38 are movable along the tubes from side to side of the cabinet chassis, such that a duct section can be supported and assembled to either side according to layout requirements.

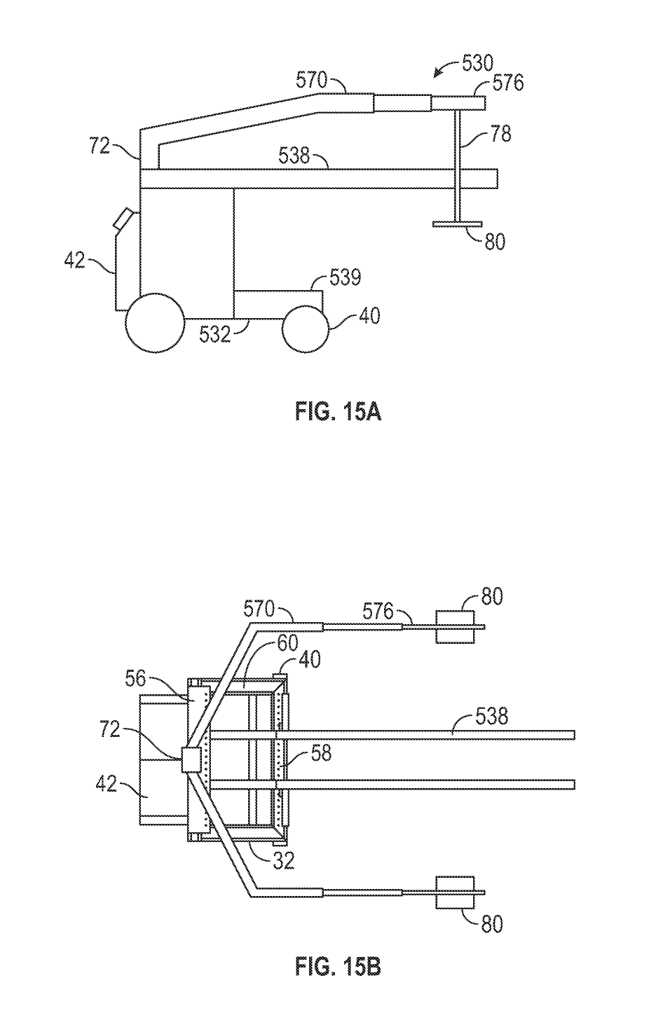

FIGS. 15A and 15B show side and top schematic views of another duct assembler 530 that includes a shortened frame 532 provided with collapsible outriggers 539. The frame includes a cabinet 42, which houses a mast system (not shown) supporting a carriage assembly 36, as in FIGS. 3 and 4. However, in place of the tines 38, the duct assembler 530 has telescoping collapsible tines 538. FIG. 16 shows an end view of three-section telescoping tines 538a, 538b, 538c. Additionally, FIGS. 15A-15B show tool trays 80 hung by arms 78 from the end pieces 576 of collapsible and extensible pipe rails 570, which extend above and horizontally outside the spread of the tines 538.

FIG. 17 shows a control panel or interface 700 usable with any of the above-described embodiments, and implementable either as an electromechanical panel box or as a display window on the integrated computer 68. Other implementations may occur to those of skill. The interface 700 includes an implementation of control unit 302 (as discussed above with reference to FIG. 13).

The interface 700 also includes a tines extension/retraction control 702. When enabled for a duct assembler with retractable tines as shown in FIG. 14, the tines extension/retraction control is connected in communication with motors in the tubes 456, which motors drive the tines 38 forward and rearward. When enabled for a duct assembler with collapsible tines 538 as shown in FIGS. 15A-16, the tines extension/retraction control is connected in communication with motorized pulleys that retract or extend push cables within the collapsible tines.

The interface 700 also includes a drop button 704, which causes the mast system 34 to automatically lower the carriage 36 by a pre-selected distance to enable disengagement of tines from a fully-installed duct section. For use with duct assemblers as shown in FIG. 14 or 15, the drop button also causes the tines extension/retraction control to retract or collapse fully rearward the tines 38 or 538.

Moreover, the interface 700 can include warning lights 706, 708, 710 indicating duct supports “in contact” (end of tines in contact with some object), “over loaded”, or “movement”. The interface also can include a reset button 712 and an emergency stop button 714. For example, the reset button may cause the carriage and tines to return to default positions, while the emergency stop may cause the carriage and tines to be hydraulically locked and braked in their instant positions.

When implemented in the integrated computer 68, the interface 700 also provides for display of an interactive electronic drawing 800, as shown in FIG. 18. The interactive electronic drawing includes individual section drawings 802. The electronic drawings may include a bill of material for a section or for all selected sections. In a first aspect, the electronic drawing displays each section drawing marked with work status codes 804. The work status codes are displayed, based on data input to the computer 68. Based on the status codes, the interactive electronic drawing also displays a Work in Place (WIP) report 806.

Exemplary data inputs to the computer 68 include touchscreen manipulation, and signals provided from the bar code reader 69 (as shown in FIGS. 3 and 4). Thus, in aspects of the invention, a bar code reader may be used to scan each duct piece as it is loaded on the duct assembler 30 or 31; again to scan each duct piece when a duct section is completely assembled; and again to scan a bar code or flag an on screen status for a fully assembled and installed section. Based on the bar code scans, the work status codes and the Work in Place Report 806 are updated at the integrated computer 68 to reflect what duct pieces have been assembled and/or installed, and how much work can be credited. For example, the work status codes 804 include “in progress”, “complete”, and “installed”. The “complete” work status code is used to calculate and display work credit for the job.

In another aspect, the interactive electronic drawing 800 also includes tap locator dimensions 808. Based on the tap locator dimensions, which are referenced to an end of each duct section, a worker W can use the duct stops 59, or the frame 32, as a datum for making tap cuts in the assembled duct section. For example, in FIG. 18A at the left, duct section marked S-24 includes a set of tap locator dimensions: 10′9″, 2″ T, 8″. These mean that the worker W should make a cut for an 8″ tap, starting 2″ down from the top of the duct piece and 10′9″ from the duct stop. The worker W makes use of the non-contact positioning system 200 to locate the starting point for making this cut, as further discussed with reference to FIG. 20. The worker W then installs a tap in the cut opening. By scanning the installed tap with the bar code reader, then the status code for the tap is updated “complete”.

In another aspect, the integrated computer 68 controls motors to operate two or more of the wheels 40. Thus, by tapping on or otherwise selecting a duct section on the interactive construction drawing 800, a worker can cause the integrated computer 68 to reposition the duct assembler in place for assembling and installing the selected duct section. This is most advantageous in cases where the appropriate duct pieces already are loaded onto the duct assembler.

In certain embodiments, the integrated computer 68 controls operation of a plasma cutter system 300 as discussed above with reference to FIG. 13. In select embodiments, each tap locator dimension can be selected by the worker W, at the interactive electronic drawing 800, thereby causing the integrated computer 68 to appropriately position and operate the plasma cutter 301. For example, selecting 10′9″ at the integrated computer will cause the control unit 302 to reposition the plasma cutter 301 to a starting position for making the 8″ cut 2″ down from the top surface of the duct piece, as specified on the interactive electronic drawing 800. Alternatively, as discussed above, the worker can manually position the plasma cutter. In certain aspects, the worker may reposition the plasma cutter based on tap data displayed at a display unit 2000, as further discussed with reference to FIG. 20.

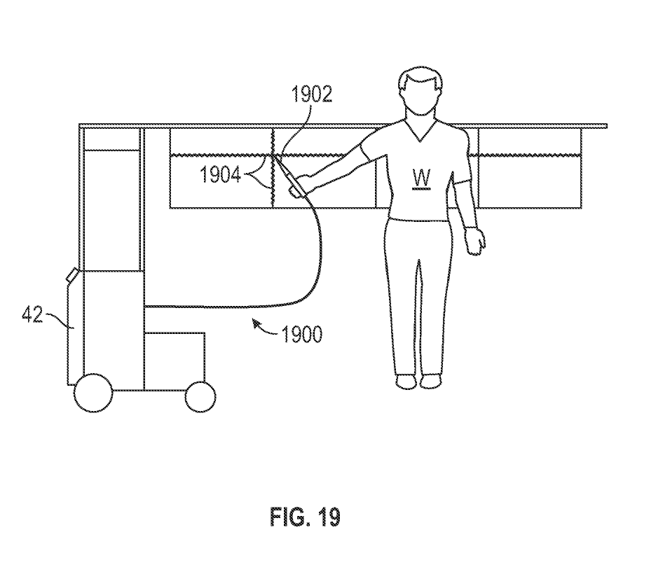

FIG. 19 shows another embodiment of the invention, which relates to welded duct work. Typically, welded duct work has been assembled and welded piece-by-piece, first doing the longitudinal seams, then the transverse joints. It would be preferable to have a way of making longitudinal welds, and a way of welding together multiple duct pieces to form a duct section, before installation, thus making a minimal number of welds at the often cramped location where the duct section is to be installed. Accordingly, FIG. 19 shows a duct assembler that includes a welder 1900 where the welder source is housed within a cabinet 42 and the welder head 1902 is available for movement along the length of tines 38. The duct assembler holds the duct pieces at an ergonomic working height, and can be adjusted up and down to enable easy access to the top and bottom of the weld seam 1904.

Referring to FIG. 20, in certain embodiments, a duct assembler includes tap data displays 2000 that are linked to the integrated computer 68 or to a separate input device. When a particular duct section is selected at the integrated computer 68, as by touchscreen interaction or the like, then tap locations and dimensions for that duct section are shown on the tap data displays. Alternatively, tap locations and dimensions (“tap data”) can be entered at a non-computer control panel by a keypad or the like. For example, tap data for left side taps are shown at display 2000a on the left side of the duct section, while tap data for right side taps are shown at display 2000b on the right side of the duct section. Based on the displayed tap data for a selected tap 2002, the worker W then can use a non-contact positioning system 200 for repositioning a plasma cutter 300, as discussed above with reference to FIG. 13. Further, the tap data displays 2000 may also indicate current position of the plasma cutter with reference to the duct stops 59, based on data from the non-contact positioning system. For example, the non-contact positioning system can include a laser measurement tool that is linked in communication with the tap data display. The tap data display then can provide visual indicators 2004 showing how the plasma cutter should be moved to the selected tap location 2002. Alternatively or additionally, the tap data display can provide a readout 2006 of the measured distance from the tap data display to the plasma cutter, reflective marker, or other position indicator.

In use, according to aspects of the invention, a duct section is assembled as follows: At a first step, a worker W loads duct pieces onto a duct assembler. Optionally, the worker scans each piece with a bar code reader as the piece is loaded, establishing work status “in progress”. Alternatively the worker can update a listing of duct pieces by interacting with an electronic drawing, generally as discussed above. The worker then uses an alignment rod to align all bolt holes, clamps the flanged ends, and removes the alignment rod. Further, the worker inserts bolts through the bolt holes and finger tightens the bolts. Once the bolts are finger tight, the worker removes clamps. The worker then fully tightens all bolts. The worker then locates and cuts openings for all taps. For example, the worker selects each tap locator dimension on an integrated computer display, then uses a non-contact positioning system for positioning and operating a plasma cutter system. Alternatively, the plasma cutter can be manually positioned. Next, the worker installs taps. Next, the worker seals flange corners and tap joints. As seals are completed on each piece or tap, the worker optionally scans that piece or tap with the bar code reader, updating work status to “complete”. Next, the worker may insulate the duct section. Finally, for duct assemblers that do not have lift capability, the worker removes the completed duct section from the duct assembler. Alternatively, a duct assembler with lift capability is used for raising and installing the duct section. The worker then may scan a bar code for the installed duct section or may update its status at the interactive electronic construction drawing.

Although the invention has been described above with reference to exemplary embodiments shown in the drawings, it will be understood by those skilled in the art that various changes in form and detail may be made without departing from the spirit and the scope of the invention. For example, selected features from one or more embodiments may be adapted into another embodiment to produce yet another embodiment of the invention.

What is claimed is:

1. A mobile duct assembler apparatus comprising:
a frame;
a vertical mast mounted to said frame;
a pair of tines extending to a sufficient distance from said vertical mast for longitudinally supporting one or more duct pieces.

2. An apparatus as claimed in claim 1, wherein the vertical mast is mounted nearer to a first end of the frame than to a second end of the frame.

3. An apparatus as claimed in claim 1, further comprising a carriage mounted on the vertical mast, wherein the tines extend from said carriage.

4. An apparatus as claimed in claim 3, wherein the tines are movably mounted on the carriage.

5. An apparatus as claimed in claim 1, wherein the vertical mast is vertically extensible to raise and lower the tines.

6. An apparatus as claimed in claim 1, wherein the tines extend to a sufficient length to longitudinally support a plurality of duct pieces assembled together as a duct section.

7. An apparatus as claimed in claim 1, wherein the tines are movable horizontally toward and away from each other for supporting one or more duct pieces of differing sizes.

8. An apparatus as claimed in claim 1, wherein the tines are retractable toward the vertical mast.

9. An apparatus as claimed in claim 8, wherein the tines are separately retractable.

10. An apparatus as claimed in claim 8, wherein each of the tines is telescopically collapsible toward the vertical mast.

11. An apparatus as claimed in claim 8, wherein each of the tines is retractable across the vertical mast.

12. An apparatus as claimed in claim 1, wherein distal ends of the tines are disposed at or beyond a first end of the frame.

13. An apparatus as claimed in claim 1, further comprising a welder housed in the frame.

14. An apparatus as claimed in claim 1, further comprising a plasma cutter movably connected with the frame.

15. An apparatus as claimed in claim 1, further comprising an integrated computer, said integrated computer including a display, a processor, and at least one input device all being associated with the frame.

16. An apparatus as claimed in claim 15, wherein the display and at least one input device are integrated as a touchscreen display.

17. An apparatus as claimed in claim 15, wherein at least one input device is a scanning device and the processor is configured to use the scanning device for identifying duct pieces.

18. An apparatus as claimed in claim 17, wherein the scanning device is integrated with the display and the processor in a tablet form.

19. An apparatus as claimed in claim 15, wherein at least one input device is a non-contact positioning system and the processor is configured to use the non-contact positioning system for positioning one or more duct pieces held on the tines.

20. An apparatus as claimed in claim 19, wherein the processor is configured for positioning the one or more duct pieces by providing directional guidance to a user of the apparatus.

21. An apparatus as claimed in claim 15, wherein the processor is configured to coordinate positioning a plasma cutter according to indications from a non-contact positioning system.

22. An apparatus as claimed in claim 21, wherein the processor is configured for positioning a plasma cutter according to indications from a non-contact positioning system, by providing visual indications to a user of the apparatus.

23. An apparatus as claimed in claim 1, further comprising a non-contact positioning system for indicating alignment to installed hangers or to an installed duct piece of a duct piece held on the tines.

24. An apparatus as claimed in claim 1, further comprising a tool tray movably supported for motion relative to the frame.

25. An apparatus as claimed in claim 24, wherein the tool tray is rectilinearly movable relative to the frame.

26. A method for assembly of duct pieces into a duct section, comprising:
supporting two or more duct pieces with adjacent openings in registry;
aligning, clamping, and fully securing and sealing together the adjacent openings to assemble a duct section, without rotating the duct section around its lengthwise axis.

27. A method as claimed in claim 26, wherein aligning, clamping, and fully securing are accomplished without vertically moving the duct section.

28. A method as claimed in claim 27, wherein the two or more duct pieces are supported at an ergonomic height.

29. A method for assembly of duct pieces into a duct section, comprising:
supporting two or more duct pieces with adjacent flanged openings in registry;
aligning, clamping, and fully securing adjacent flanges to assemble a duct section, without vertically moving the duct section.

30. A method as claimed in claim 29, wherein the two or more duct pieces are supported at an ergonomic height.

31. A method for vertically positioning a duct section, comprising:
supporting the duct section along at least a majority of its length; and
vertically adjusting the support to position the duct section.

32. A method as claimed in claim 31, wherein supporting includes horizontally adjusting a support to match a width of the duct section.

33. A method as claimed in claim 31, wherein supporting includes internally supporting the duct section.
